(19) United States
(12) Patent Application Publication
(10) Pub. No.: US 2003/0120659 A1
(43) Pub. Date: Jun. 26, 2003

(54) Systems for developing websites and methods therefor

(76) Inventor: Mandayam Anandampillai Sridhar, San Jose, CA (US)

Correspondence Address: Joseph A Nguyen, 3410 Antonacci Ct, San Jose, CA, 95148, US

(21) Appl. No.: 09/531,980

(22) Filed: Mar. 20, 2000

(51) Int. Cl. G06F 7/00

(52) U.S. Cl. 707/100; 707/102

(57) ABSTRACT

A computer-implemented method for facilitating website development by a website developer from a supplied data schema. The method includes generating a plurality of user data models from the data schema and generating a plurality of data views from the plurality of user data models. The method also includes receiving from the website developer at least one data view choice, the data view choice indicating a selection of a particular data view from the plurality of data views. Additionally, there is included creating backend logic to support the particular data view and creating a user interface front-end to present the particular data view on an output device.

### BACKGROUND OF THE INVENTION

The present invention relates to techniques for developing websites for individuals and businesses. More particularly, the present invention relates to improved techniques for developing websites that are highly decoupled for maintainability and scalability while requiring little programming knowledge on the part of the website developers.

Website development to date has been the province of the sophisticated computer programmers and technologists. A website that includes a front-end user interface, an application layer for performing business or logic operations, and a backend database engine typically requires one or more engineers well versed in programming languages to put together. The bulk of websites today has been built using two approaches: brute force and via some type of application development tool. In the brute force approach, each webpage is hand coded using an appropriate language such as Java, Perl, ASP, TCL, HTML, and the like. The programmer would create codes for interfacing with the user, for performing the required business/logic operation, and for interacting with the backend database. To speed up website development and alleviate some of the more tedious aspects of hand coding, an application development tool may be employed. Application development tools include such integrated development environments as Visual InterDev, PowerBuilder, Designer, and WebDB. However, a substantial amount of programming knowledge and sophisticated technical skills are still required to develop a website using one of the commercially available application development tools.

Under either approach, the high level of technical knowledge required has made it difficult for many to develop their own website. Even when an application development tool is employed, there are significant disadvantages. By way of example, there may be ongoing licensing costs if one of the proprietary application development tool engines is required for website operation and/or maintenance. Furthermore, a given application development tool may require a specific platform to run on, which in turn ties the website owner to a particular platform. Sometimes, a given application development tool may not be compatible with the legacy hardware/software that the business may employ prior to undertaking website development. The platform-specific nature of some application development tool also makes it difficult to enhance and/or scale the website to offer additional features and/or service additional customers. This is because such enhancement or scaling may exceed the capability offered by the application development tool itself. Still further, it is sometimes difficult to maintain websites developed via an application development tool since the proprietary engine may not be accessible for updates and/or changes if features need to be added and/or modified.

### SUMMARY OF THE INVENTION

The invention relates, in one embodiment, to a computer-implemented method for facilitating website development by a website developer from a supplied data schema. The method includes generating a plurality of user data models from the data schema and generating a plurality of data views from the plurality of user data models. The method also includes receiving from the website developer at least one data view choice, the data view choice indicating a selection of a particular data view from the plurality of data views. Additionally, there is included creating backend logic to support the particular data view and creating a user interface front-end to present the particular data view on an output device.

In another embodiment, the invention relates to a computer-implemented method for facilitating website development by a website developer from a supplied data schema. The method includes automatically generating a plurality of user data models from the data schema. The plurality of user data models represents all possible different combinations of user data models from the data schema. The method also includes receiving from the website developer at least one choice that indicates a selection of a particular data view associated with one of the plurality of user data models. Further more, the method includes creating backend logic to support the particular data view and creating a user interface front-end to present the particular data view on an output device.

In yet another embodiment, the invention relates to a computer-implemented method for facilitating website development by a website developer from a supplied data schema. The method includes receiving at least one user data model from the website developer. The user data model pertains to a specific representation of data relationship among data attributes in the data schema. The method includes automatically generating a data view from the user data model, automatically creating backend logic to support the data view, and automatically creating a user interface front-end to present the data view on an output device.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows, in one example, a diagram of a simple data schema that includes three tables in a relational database.

FIG. 2 illustrates a tree representing an automatically generated user data model.

FIG. 3 shows one of the steps in the process of creating a new model.

FIG. 4 illustrates a completed user data model tree in the left pane, with the automatically-generated HTML code in the right pane.

FIG. 5 shows, in accordance with one embodiment, a simplified flowchart illustrating the general steps involved in developing a website

FIG. 6 shows an example of a data schema that involves many interrelated entities.

FIG. 7 shows, in one embodiment, an exemplary user data model that supports a more complex data view than that associated with FIG. 2.

FIG. 8 shows, in accordance with one embodiment, a simplified flowchart illustrating the general steps involved in developing a website having relatively complex data views.

### DETAILED DESCRIPTION OF THE PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In accordance with one aspect of the present invention, user data models are automatically created from a furnished data schema. The data schema is generally implemented by tables of a relational database. In one aspect of the present invention, all possible user data models are automatically generated from the furnished data schema. In generating the user data models, links between tables in the data schema are inferred automatically. The user data models are then employed to automatically generate a plurality of data views, which are data output representations of the user data models. These data views may then be provided to the website developer for selection. The website developer may then choose one or more data views to be created. Once a data view is selected, the backend logic is then automatically generated, typically as codes such as SQL, Java, Perl, or TCL codes. The backend logic represents the logic employed to extract data from the database and to manipulate the extracted data to obtain the desired data output. Furthermore, the data view output for the selected data view is automatically generated in a generic webpage, which may then be customized by the website developer to fit the desired data presentation format.

As can be appreciated from the foregoing, website development is substantially simplified in that once the data schema is furnished, the data views are automatically created for selection by the website developer. Selecting the desired data views (e.g., by clicking on selected ones in the list of all possible data views) causes the backend logic and front-end data view output to be automatically generated for each of the selected data views. At this point, all the website developer needs to do is to customize the generic webpages that contain the data view outputs, and website development is substantially done.

In another aspect of the present invention, it is recognized that some relational database may be so voluminous and/or the relationship between tables in such databases may be so complex that the number of possible combinations of user data models may be very large. Even if there is sufficient computing power to generate such large combinations in a reasonable amount of time, it is recognized that the website developer may be overwhelmed with the choices available, making the whole system less than user friendly. In this case, it is preferable that the website developer be furnished with a tool to edit his own user data model in order to more directly specify the data view desired. From the developer-specified user data model, links may be inferred automatically and a data view may be automatically created therefrom. For this data view, the backend logic may also be automatically generated, and the data view output automatically generated as well on a generic webpage. Again, the website developer may modify the generic webpage as necessary to conform the output to the desired data presentation format.

Whether the user data model is automatically generated or specified by the website developer, the present invention simplifies the process of building a website to nonprogramming steps to allow websites to be developed even by people who have only modest technical skills. Furthermore, the process is platform-independent in that the resultant website does not depend on any particular proprietary engine of any application development tool for operation and/or maintenance. This is because the backend logic is preferably generated as platform-independent codes (such as Java, Perl or TCL). The data view output is also generated using platform-independent interfaces such as webpages. Accordingly, scalability, maintainability, and cross-platform compatibility are ensured. The process does not, however, preclude the use of platform-specific technologies such as C/C++ or Microsoft ASP, if such is desired.

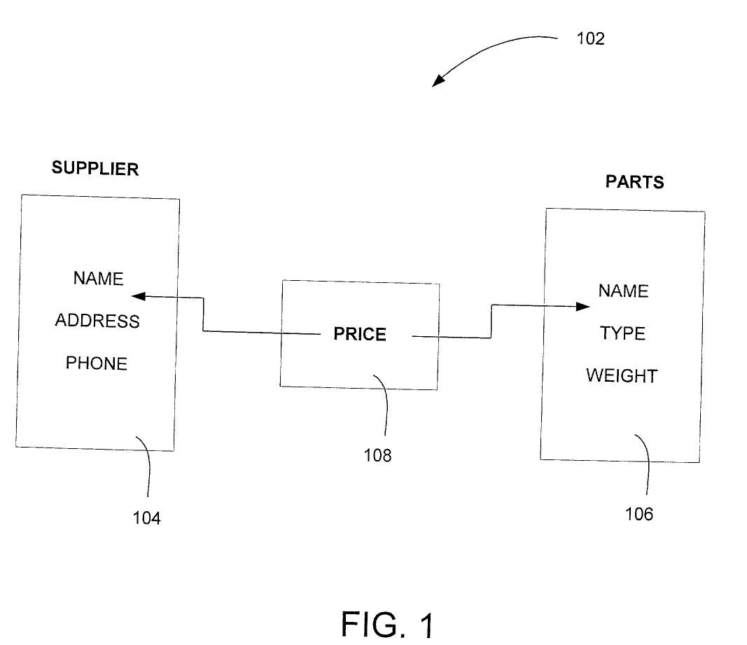

These and other advantages and features of the present invention may be better understood with reference to the figures and discussion below. FIG. 1 shows, in one example, a diagram of a simple data schema 102 that includes three tables in a relational database. In general, a data schema may be thought of as the backend relationship among data tables in a relational database. In the present example, data schema 102 represents a data schema that models the relationship between a supplier and parts for a fictitious purchaser of such parts. As such, a supplier table 104 having attributes such as “name” “address” and “phone” are shown, along with a part table 106, which has attributes such as “name” (for name of the part), type, weight. Of course other attributes are also possible, although only a few are shown here to simplify the discussion.

These two tables 104 and 106 are linked by a link table 108, which may contain, for example, a price attribute. Link table 108 describes the attributes of the relationship between supplier and parts. For example, link table 108 may answer questions such as “I'm interested in knowing the price at which specified suppliers will sell a specific part.” There may also be other link tables that describe other attributes of the relationship between the supplier and the part. For simplicity, other link tables are not shown. The data schema of FIG. 1 is conventional and is familiar to one skilled in the relational database art.

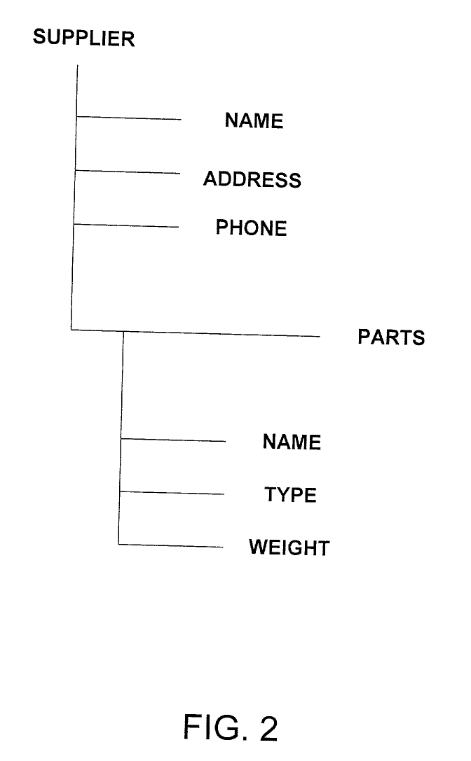

From data schema 102 of FIG. 1, a set of user data models may be specified. In one embodiment, all possible user data model combinations are generated. To automatically generate a user data model, a tree is created with the root node corresponding to a primary database table, and a child node corresponding to a related table. In the example of FIG. 1, the root node is the supplier 104 and the child node is the part 106. Such a tree is shown in FIG. 2. Note that under the root node “Supplier,” all the fields of supplier table 104 are shown under the root node (such as “name” “address” and “phone”). Under the child node “Part”, all the fields of the part table 106 are shown (such as “name,” “type” and “weight”).

At this point, it is possible (at least theoretically) identify every possible user data model that can be constructed from a given schema. Three examples illustrate this. In the first example, there is one model for each table in the database. Such a model includes just the data elements (columns) of the table in question. In the second example, there is one model for each pair of “related” tables. Two tables are deemed “related” if there is a reference from one to the other in the database. In the third example, there is one model for each three “related” tables containing at least one chain of relationships among them.

Larger numbers of related tables may be analyzed similarly. However, the number of possible models soon becomes very large. The database schema may be viewed as a graph whose nodes are tables and whose edges are relationships between tables. This perspective facilitates the application of standard graph-theoretic algorithms for enumerating the data models as well as for generating the back-end code.

To illustrate the mechanism of constructing the Java and SQL code for handling backend logic, the supplier-parts data schema may be employed as a running example. Each database table is represented by a Java class, and an instance of such a class contains a record of the table. In addition, a second Java class encapsulates the database logic and the SQL code.

For a single table, the SQL code for retrieving, storing and modifying the data in the table can be automatically created and embedded into the Java classes. For instance, for the above supplier-parts example, the code below shows parts of the Java classes corresponding to the Part table. Note that reference line numbers have been added to the codes for ease of reference. In the production codes, these reference numbers do not exist.

| | |
|---|---|
| 1 | /** |

| | |
|---|---|
| 2 | * Construct an instance of Part from an explicit list of |
| 3 | * parameters. |
| 4 | */ |

| | |
|---|---|
| 5 | public Part |

| | |
|---|---|
| 6 | ( |

| | |
|---|---|
| 7 | int Id |
| 8 | , java.lang.String Part_number |
| 9 | , java.lang.String Name |
| 10 | , int weight |

| | |
|---|---|
| 11 | ) { |
| 12 | _valueHash = new Hashtable( ); |
| 13 | |
| 14 | _valueHash.put (“Id”.new Integer (Id) ); |
| 15 | _valueHash.put (“Part_number”.Part_number): |
| 16 | _valueHash.put (“Name”, Name); |
| 17 | _valueHash.put (“weigh”, new Integer (weight) ); |

| | |
|---|---|
| 18 | } |
| 19 | public Vector getObjects |
| 20 | (String whereClause, String otherTableNames, DbConnection |
| 21 | connection) throws SQLException { |
| 22 | String fieldString = “ ” |
| 23 | |

| | |
|---|---|
| 24 | + “ Part.Id” |
| 25 | + “, Part.Part_number” |
| 26 | + “, Part.Name” |
| 27 | + “, Part.weight” |

| | |
|---|---|
| 28 | String fromClause = “Part” |
| 29 | if (otherTableNames != null && otherTableNames.length( ) > 0) |

| | |
|---|---|
| 30 | fromClause += “,” + otherTableNames; |

| | |
|---|---|
| 31 | String sqlString = “select” + fieldString + “ from ” + fromClause; |
| 32 | if (whereClause != null && whereClause.length( ) > 0) |

| | |
|---|---|
| 33 | sqlString +=“ where ” + whereClause; |

| | |
|---|---|
| 34 | QueryResponse q = connection.executeSql (sqlString); |
| 35 | ResultSet r = q.resultSet( ); |
| 36 | Vector v = new Vector( ); |
| 37 | _seenIdsSet.clear( ); |
| 38 | while (r.next( ) ) { |

| | |
|---|---|
| 39 | Integer primaryKey = new Integer (DbUtils.getint (r, “Id”) ); |
| 40 | if (!_seenIdsSet.contains (primaryKey) ) { |

| | |
|---|---|
| 41 | v.addElement (buildFromResultSet (r) ); |
| 42 | _seenIdsSet.add (primaryKey); |

| | |
|---|---|
| 43 | } |

| | |
|---|---|
| 44 | } |
| 45 | q.close( ); |
| 46 | return v; |

| | |
|---|---|
| 47 | } |
| 48 | |
| 49 | /** |

| | |
|---|---|
| 50 | * Save the given object into the database via the given connection. If |
| 51 | * the object has an id of zero, it is treated as a request to insert a |
| 52 | * new record into its table. Otherwise, this is treated as an update |
| 53 | * request. In either case, this method returns the id of the inserted |
| 54 | * or updated object. |
| 55 | */ |

| | |
|---|---|
| 56 | public int saveToDatabase (DbObject object, DbConnection connection) |

| | |
|---|---|
| 57 | throws java.sql.SQLException { |
| 58 | int id = object.id( ); |
| 59 | if(object.id( ) != 0) { |

| | |
|---|---|
| 60 | modifyDatabaseRecord (id, object, connection); |

| | |
|---|---|
| 61 | } else { |

| | |
|---|---|
| 62 | String sqlString = “insert into Part (” |
| 63 | |

| | |
|---|---|
| 64 | + “Id” |
| 65 | + “,Part_number” |
| 66 | + “,Name” |
| 67 | + “,weight” |
| 68 | + “) values (” |
| 69 | |
| 70 | + “ ”+ |
| 71 | “Part_sq.nextval” |
| 72 | + “,” + DbUtils.sqlRep ( (java.lang.String) object.valueOfAttribute |

(“Part_number”) )

| | |
|---|---|
| 73 | + “,” + DbUtils.sqlRep ( (java.lang.String) object.valueOfAttribute |

(“Name”) )

| | |
|---|---|
| 74 | + “,” + DbUtils.sqlRep ( (Integer) object.valueOfAttribute (“weight”) ) |
| 75 | + “)”; |

| | |
|---|---|
| 76 | connection.beginTransaction ( ); |
| 77 | |
| 78 | QueryResponse q = connection.executeSql (sqlString); |
| 79 | q.close( ); |
| 80 | |
| 81 | |
| 82 | // Get the id of the newly-inserted record, and set it as the id |
| 83 | // of the object |
| 84 | sqlString = “select Part_sq.currval from dual”; |
| 85 | QueryResponse ql = connection.executeSql (sqlString); |
| 86 | ResultSet r = ql.resultSet( ); |
| 87 | if (r.next( ) ) |

| | |
|---|---|
| 88 | object.setId (r.getInt (1) ); |

| | |
|---|---|
| 89 | connection.commitTransaction ( ); |
| 90 | q1.close( ); |

| | |
|---|---|
| 91 | } |
| 92 | return objectid( ); |

| | |
|---|---|
| 93 | } |

The code lines 7-10, 14-17, 24-27, 64-67, and 72-74 illustrate places where the generator introduces lists of attribute names corresponding to the actual attributes of the table. Thus the process for constructing the Java classes corresponding to the database tables is as follows. First, aAnalyze the database schema and create a list of tables, and a list of attributes for each table. Thereafter using a pre-created Java class template, create two classes for each table in the list, by replacing occurrences of the table name and list of attributes by the corresponding values. This accounts for both the Java code and the embedded SQL code. Thereafter, outputting the resulting Java classes.

There is created “generic” back-end Java code that relies on the automatically-generated Java classes for correct operation with multi-table user-data models. The code is generic, in that its structure does not rely either on a particular table structure or a particular user data model structure. It merely assumes that the user data model is laid out as a tree, as shown in the earlier diagram. Generally speaking, this code operates as follows:

First, inspect the tree structure of the user data model, and with each non-leaf element of the tree, associate the two Java classes corresponding to the table for which the node is created.

To retrieve data associated with the model, traverse the tree from root to leaf. For each non-leaf node encountered along the way, invoke the data retrieval methods of the corresponding Java classes, and accumulate the results in an internal data structure. Return this data structure when the traversal is complete.

To store data associated with the model, traverse the tree from root to leaf, and insert the associated data into the database. Data storage is complicated by the fact that the foreign-key dependencies in the database are not necessarily consistent with the ordering of data elements in the tree. Consequently, it is desirable to compute, a priori, a topological sort ordering of the tables, so that non-dependent tables occur before dependent tables in the ordering. (Topological sorting is a widely-known algorithm in graph theory, and we have applied it to database schemas.) During data storage, it is desirable that data is inserted in tables according to their order of occurrence in the topological sort ordering.

As indicated earlier, determining the collection of all user data models to be generated is simply a matter of constructing a graph model for the database schema and identifying all 2-table, 3-table (or multi-table) relationships in which there is at least one chain of dependencies among the tables. Determining such table groups is a matter of using a suitable graph algorithm (e.g., breadth-first search). For each such group, construct all the possible user data model trees and present them as possibilities to the user.

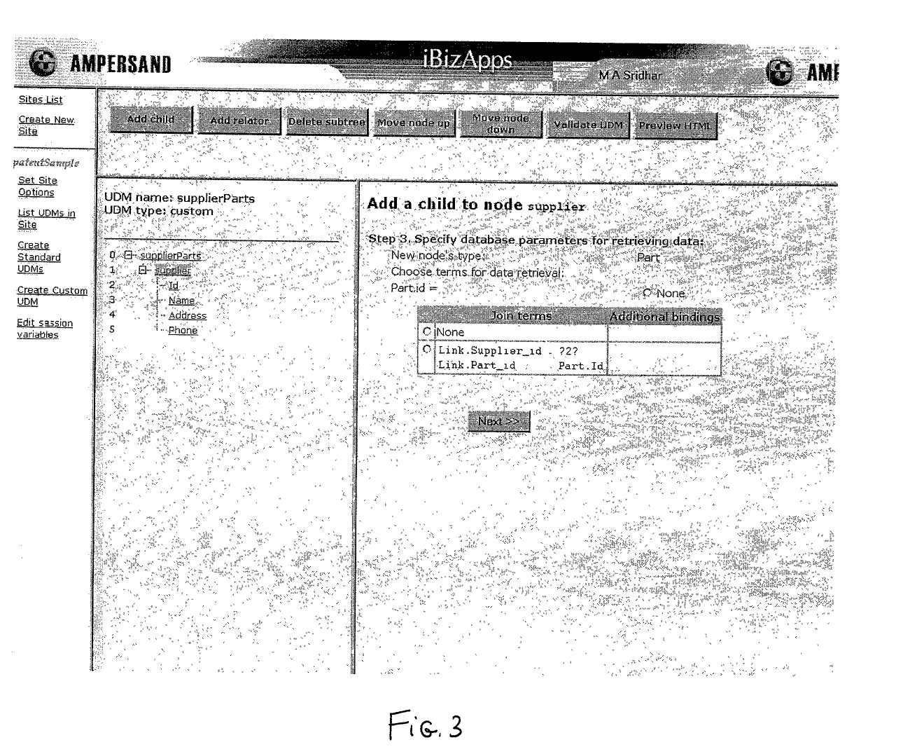

FIG. 3 shows one of the steps in the process of creating a new model. The schema used in creating this model is the same as that of FIG. 1. This particular step is an intermediate step in adding a child named “part” to the node named “supplier”, and highlights the fact that the system has automatically determined the identity of the linking table and therefore the possible “join terms” in the SQL to be generated.

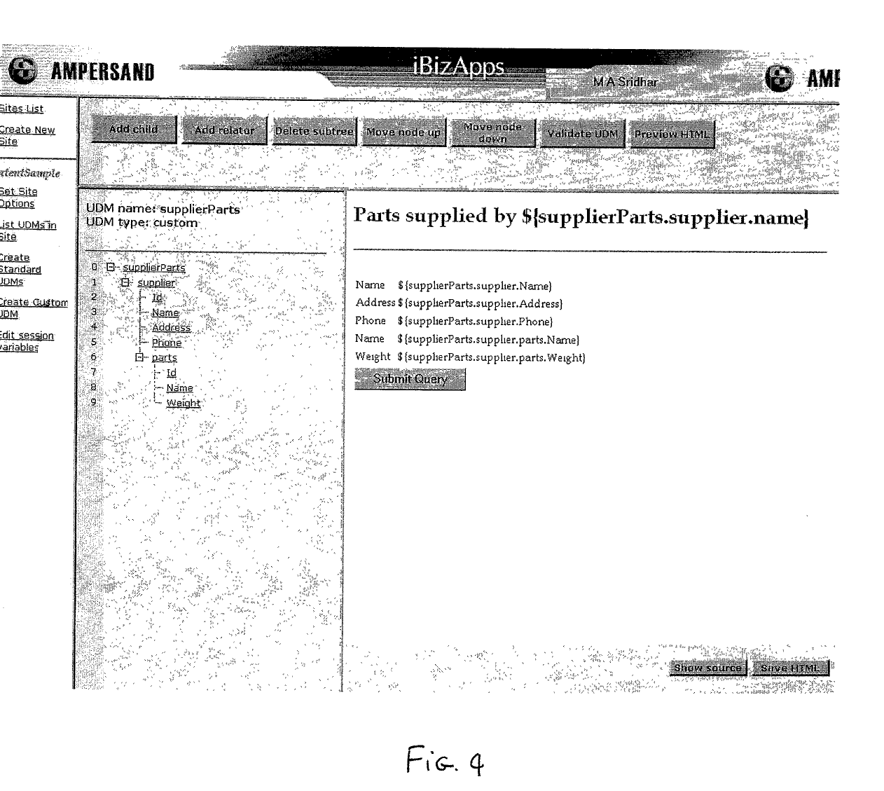

FIG. 4 illustrates a completed user data model tree in the left pane, with the automatically-generated HTML in the right pane.

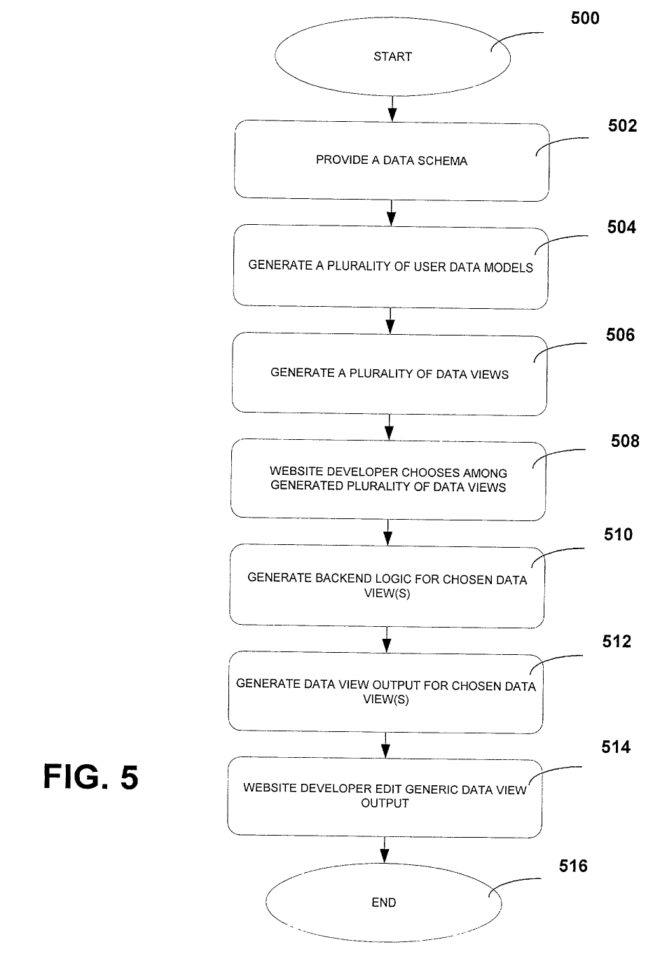

FIG. 5 shows, in accordance with one embodiment, a simplified flowchart illustrating the general steps involved in developing a website. In step 502, a data schema is provided. As mentioned, this data schema represents tables in a relational database from which the user wishes to obtain one or more specific data views in one or more webpages or other output medium. In step 504, a plurality of user data models are automatically generated. In one embodiment, the user data models generated in step 504 represents all possible combinations of data views. Note that as the term is employed herein, automatic generation denotes the fact that the generation of the thing generated is performed using computer-implemented logic instead of using a manual (whether by hand or computer-assisted) method. Automatic generation does not preclude (by also does not require) the possibility that the website developer may issue one or more commands to start the generation of the thing generated.

In step 506, data views are generated from the user data models generated in step 504. In step 508, the website developer chooses from among the data views generated in step 506 one or more desired data views. By way of example, the data views generated in step 506 may be presented in a list form and the website developer merely checks off the desired data views from the list. Once the desired data views are ascertained, links may be inferred from the user data models associated with the desired data views, and the backend logic therefor may be automatically generated (step 510). In step 512, the user interface front-end is generated. In this step, the data view output for a selected data view may be created on one or more generic webpages. Note that although the webpage example is employed herein to simplify the discussion, it should be noted that the data view output may be created (and subsequently modified by the website developer) in any suitable and/or specified user-interface front end. Examples of suitable user-interface front ends include Internet-enabled telephones, Wireless Application Protocol-enabled cellular phones, Internet-enabled handheld computers, Internet-enabled two-way pagers, and the like.

In step 514, the website developer may edit the generic webpage output to conform the data to a desired data presentation format (for example to enhance aesthetics, readability, or user-friendliness).

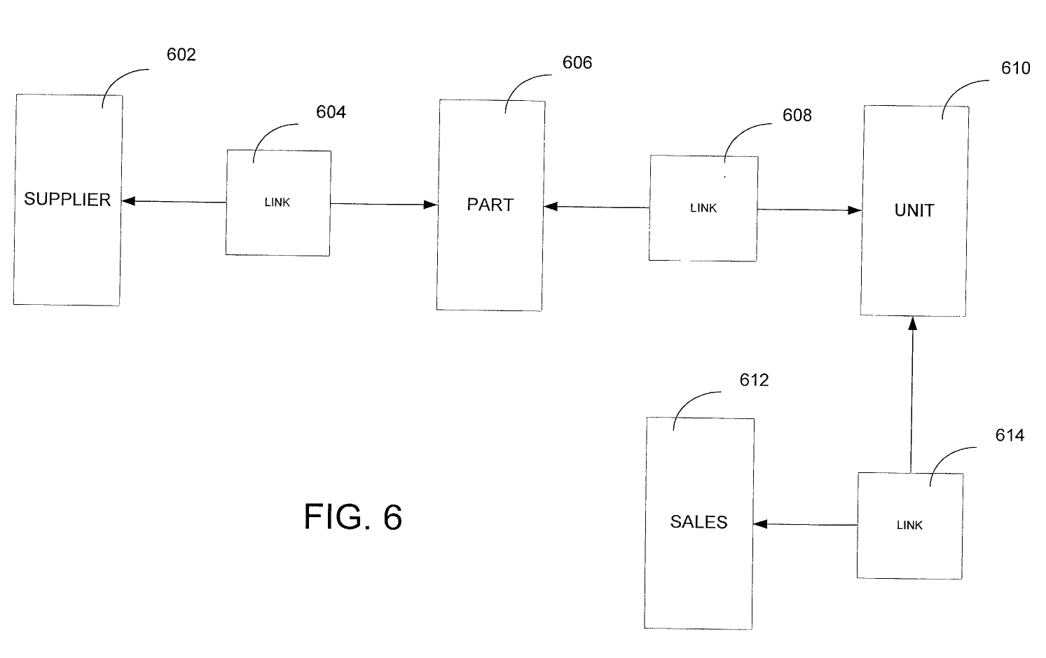

When a more complex data schema is involved and/or where the relationship among multiple tables is complex, it may be desirable to receive the user data model directly from the website developer instead of generating all possible user data models for the website developer to choose. FIG. 6 shows an example of a data schema that involves many interrelated entities. In the example of FIG. 6, one may want to keep track of sales by unit, with each unit having multiple parts and each part supplied by multiple suppliers. If the user desires a view that shows all sales 614 by a particular supplier 602 and also the parts (606) which contributes to the sales. Automatically generating all user data models for the data schema of FIG. 6 may result in a massive list of user data models and data views from which the website developer must search through and select the desired ones. In this case, the provision of an editing tool that allows the website developer to specify the exact user data model associated with the desired data view may be highly useful.

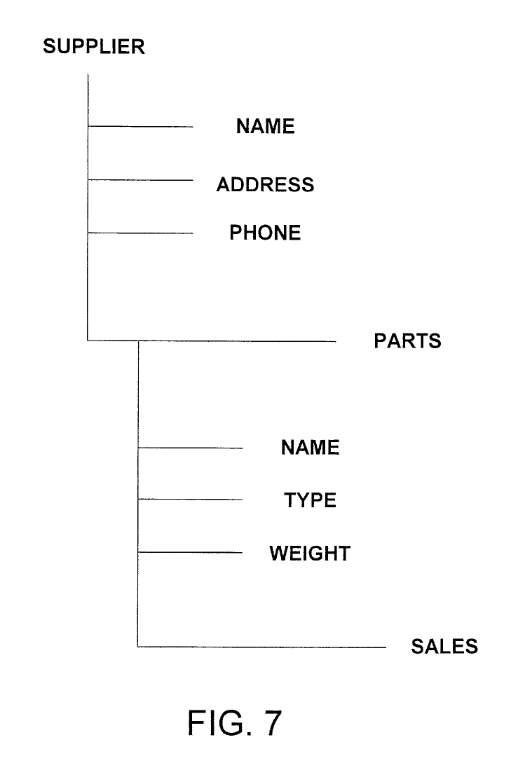

FIG. 7 shows, in one embodiment, an exemplary user data model that supports a more complex data view than that associated with FIG. 2. In FIG. 7, the supplier 702 may be, for example, AC-Delco and the part 704 may be, for example, radios, speakers, cassette decks, and the like. Sales 706 reflects the sales associated with the part 704 from the supplier 702. With a user data model editing tool, the user data model hierarchy of FIG. 7 may be input by the website developer. From the supplied user data model, the system may then automatically infer links to create the backend logic (e.g., the the SQL or Java codes). Thereafter, the user interface front-end is generated for the data view associated with the supplied user data model.

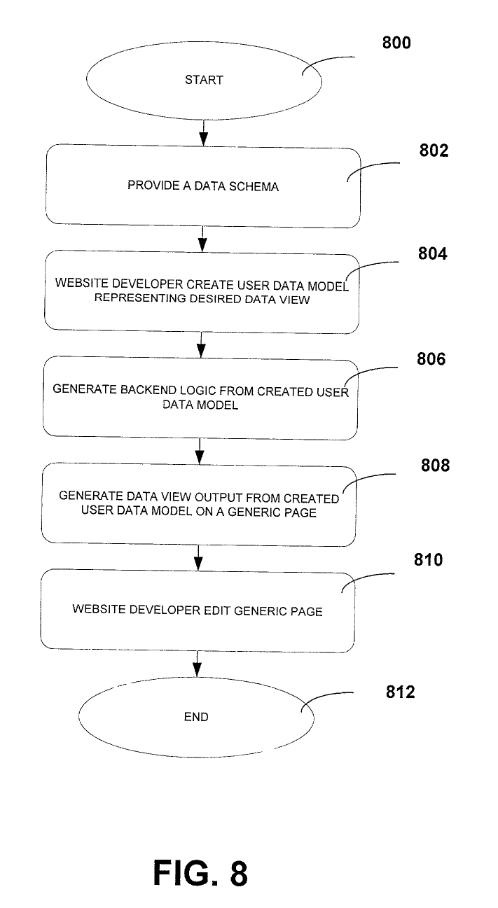

FIG. 8 shows, in accordance with one embodiment, a simplified flowchart illustrating the general steps involved in developing a website having relatively complex data views. In step 802, a data schema is provided. In step 804, the website developer may employ an editing tool to create a user data model that represents the desired eventual data view.

In step 806, links may be inferred from the user data model furnished by the website developer, and the backend logic therefor may be automatically generated. In step 808, the data view output is generated. In this step, the data view output for a data view may be created on one or more generic webpages. In step 810, the website developer may edit the generic webpage output to conform the data to a desired data presentation format (for example to enhance aesthetics, readability, or user-friendliness).

As can be appreciated from the foregoing, the invention facilitates the development of websites without requiring the website developer to have in-depth programming knowledge or sophisticated technical understanding of website development. Even for those having a high level of technical sophistication, the present invention simplifies the website development process in that it essentially reduces website development to a series of choices to be made (e.g., choice of data views in the case where all data views are generated) or simple editing of the user data model that represents the desired eventual data view. The steps in between, i.e., the creation of the backend logic that interfaces with the database and manipulates the data as well as the outputting of the data view output on a user-interface front end, are automatically performed for the website developer. The website developer remaining task is then to beautify the generic data view output to conform to his desired data presentation format.

This is in contrast to the prior art approach wherein the website developer is engaged to write programming codes for each data view desired. Whenever a new data view is desired, new codes must be written and new HTML pages must be coded. In the present invention, the addition of a new data view involves choosing the desired data view from the list of all possible data views and then beautifying the result (in the case of relatively simple data relationship) or specifying the user data model representing the desired eventual data view and then beautifying the result (in the case of more complex data relationship). In either case, the burden on the website developer is substantially lower.

Furthermore, the invention facilitates the creation of a website that is highly decoupled and platform independent. This is in contrast to the platform-dependent, black-box nature of prior art application development tool environments. In the present invention, the backend logic is generated independent of the front-end user interface. The backend logic is preferably generated using a cross-platform language to allow the developed website to be deployed on a wide variety of computers and operating systems, which reduces the possibility of incompatibility with the customers' legacy computing resources and promotes maintainability. The front end user interface is decoupled from the backend logic and is also generated in a language that is also platform-independent (such as HTML or XML).

While this invention has been described in terms of several preferred embodiments, there are alterations, permutations, and equivalents which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer-implemented method for facilitating website development by a website developer from a supplied data schema, comprising:
generating a plurality of user data models from said data schema;
generating a plurality of data views from said plurality of user data models;
receiving from said website developer at least one data view choice, said data view choice indicating a selection of a particular data view from said plurality of data views;
creating backend logic to support said particular data view; and
creating a user interface front-end to present said particular data view on an output device.

2. The method of claim 1 wherein said plurality of user data models represents all possible different combinations of user data models from said data schema.

3. The method of claim 2 wherein said plurality of user data models are computer-generated from said data schema.

4. The method of claim 1 wherein said plurality of data views represents all possible different combinations of data views from said data schema.

5. The method of claim 1 wherein said data schema includes relational database tables.

6. The method of claim 1 wherein said backend logic includes SQL codes.

7. The method of claim 1 wherein said user-interface front-end is a webpage.

8. The method of claim 1 wherein said user-interface front-end is a Internet-enabled telephone user interface.

9. The method of claim 1 wherein said user-interface front-end is an Internet-enabled handheld computer interface.

10. The method of claim 1 further comprising customizing said user-interface front-end to conform data in said particular data view to a given format.

11. A computer-implemented method for facilitating website development by a website developer from a supplied data schema, comprising:
automatically generating a plurality of user data models from said data schema, said plurality of user data models represents all possible different combinations of user data models from said data schema;
receiving from said website developer at least one choice, said at least one choice indicating a selection of a particular data view associated with one of said plurality of user data models;
creating backend logic to support said particular data view; and
creating a user interface front-end to present said particular data view on an output device.

12. The method of claim 11 wherein said data schema includes relational database tables.

13. The method of claim 11 wherein said backend logic includes SQL codes.

14. The method of claim 11 wherein said user-interface front-end is a webpage.

15. The method of claim 11 further comprising customizing said user-interface front-end to conform data in said particular data view to a given format.

16. A computer-implemented method for facilitating website development by a website developer from a supplied data schema, comprising:
receiving at least one user data model from said website developer, said user data model pertains to a specific representation of data relationship among data attributes in said data schema;
automatically generating a data view from said user data model;
automatically creating backend logic to support said data view; and
automatically creating a user interface front-end to present said data view on an output device.

17. The method of claim 16 wherein said data schema includes relational database tables.

18. The method of claim 17 wherein said automatically generating said data view includes generating links among said relational database tables responsive to said user data model.

19. The method of claim 16 wherein said backend logic includes SQL codes.

20. The method of claim 16 wherein said user-interface front-end is a webpage.

21. The method of claim 20 further comprising customizing said webpage to conform data in said data view to a given format.

22. A computer-implemented method for facilitating website development by a website developer from a supplied data schema, comprising:
receiving a plurality of user data models from said website developer, said user data models pertain to a plurality of representations of different data relationships among data attributes in said data schema;
automatically generating a plurality of data views from said plurality of user data models;
automatically creating backend logics to support said plurality of data views; and
automatically creating user interface front-ends to present said plurality of data views on an output device.

23. The method of claim 22 wherein said data schema includes relational database tables.

24. The method of claim 22 wherein said backend logic includes SQL codes.

25. The method of claim 22 wherein said user-interface front-end is a webpage.

26. The method of claim 25 further comprising customizing said webpage to conform data in said data view to a given format.
